(19) United States
(12) Patent Application Publication
(10) Pub. No.: US 2007/0222846 A1
(43) Pub. Date: Sep. 27, 2007

(54) Transport path switching device in double-sided recording apparatus, double-sided recording apparatus having the same and double-sided liquid ejecting apparatus

(75) Inventors: Kazuhisa Nakamura, Matsumoto-shi (JP); Shintaro Komuro, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/726,916

(22) Filed: Mar. 23, 2007

(30) Foreign Application Priority Data
Mar. 23, 2006 (JP) 2006-080867
Sep. 5, 2006 (JP) 2006-240558

(51) Int. Cl. B41J 2/01

(52) U.S. Cl. 347/104

(57) ABSTRACT

A transport path switching device for switching a straight transport path for carrying out the recording operation over the rigid medium and a double-sided recording transport path having a medium inverting path branched in a middle of the straight transport path in order to carry out the recording operation over the both sides of the non-rigid medium, includes:

a rotatable gate member, provided at a portion in which the medium inverting path is branched from the straight transport path; and a flap, formed with the gate member and adapted to guide the non-rigid medium to the medium inverting path. When the rigid medium is transported, a part of the rigid medium acts on the gate member directly or indirectly, thereby rotating the gate member in such a direction that the flap is opened, and the rigid medium can pass through a position of the flap to advance straight.

### BACKGROUND

1. Technical Field

The present invention relates to a transport path switching device in a double-sided recording apparatus, and the double-sided recording apparatus having the same. Furthermore, the invention relates to a double-sided liquid ejecting apparatus such as an ink jet type recording apparatus for ejecting a liquid such as an ink from a head thereof, thereby executing an ejection onto a medium to be ejected.

The liquid ejecting apparatus is used to include recording apparatuses, for example, a printer utilizing an inkjet type recording head and ejecting an ink from the recording head to carry out a recording operation over a medium to be recorded, a copying machine and a facsimile, and furthermore, an apparatus for ejecting a liquid corresponding to the uses in place of the ink from a liquid ejecting head which is equivalent to the recording head onto a medium to be ejected which is equivalent to the medium to be recorded and sticking the liquid to the medium to be ejected.

Examples of a liquid ejecting head include, in addition to the recording head, a coloring material ejecting head to be used for manufacturing a color filter such as a liquid crystal display, an electrode material (conductive paste) ejecting head to be used for forming an electrode such as an organic EL display or a face emitting display (FED), a bioorganism ejecting head to be used for manufacturing a biochip, and a specimen ejecting head to be a precision pipette.

2. Related Art

JP-A-2004-315195 has disclosed a structure in which there are provided a first paper path returned from a-paper feed roller through a paper inverting portion to the paper feed roller and a second paper path extended almost linearly to an upstream side of the paper feed roller, and the first paper path and a part of the second paper path is constituted by a common paper path, and a moving flap for switching a paper path is disposed on the common paper path so that the moving flap is retracted when a medium to be recorded which has a high rigidity is inserted to press the moving flap.

Moreover, JP-A-7-323941 has disclosed such a structure as to provide an inverter which causes both a single-sided sheet (to be printed on one side thereof) and a double-sided sheet (to be printed on both sides thereof) to be transported along a common input path and controls the sheets so as to be transported along the common path, and returns the sheets in an opposite direction to a direction of the transport of the sheets or causes the sheets to pass earlier in a transport direction of the sheets in which the sheets are initially transported.

In the art disclosed in JP-A-2004-315195, however, the operation of the moving flap is controlled depending on a rigidity and a transporting force of the paper. For this reason, it is necessary to take the type and rigidity of the paper or a variation in the transporting force into consideration. As a result, a layout is complicated and it is hard to design it. Moreover, an urging force of the moving flap is to be usually made greater than the transporting force of the paper. Therefore, there is a problem in that a transporting load received by the medium from the moving flap is increased at the time when the paper is transported to the second paper path which is extended almost linearly.

On the other hand, in the art disclosed in JP-A-7-323941, an operation of a gate is controlled by a controller. Therefore, a driving mechanism and a control mechanism are required. For this reason, there is a problem in that a size of the apparatus is increased, and furthermore, a cost is increased and a design is complicated.

### SUMMARY

An advantage of some aspects of the invention is to provide a transport path switching device in a double-sided recording apparatus which can reliably control a gate member for switching a straight path and a path for inverting a medium to be recorded irrespective of a rigidity and a transporting force of the recorded medium itself, the double-sided recording apparatus having the same, and a double-sided liquid ejecting apparatus.

According to an aspect of he invention, there is provided a transport path switching device in a double-sided recording apparatus having a mode for carrying out a recording operation over a single side of a non-rigid medium, a mode for carrying out the recording operation over both sides of the non-rigid medium, and a mode for carrying out the recording operation over a rigid medium, the transport path switching device for switching a straight transport path for carrying out the recording operation over the rigid medium and a double-sided recording transport path having a medium inverting path branched in a middle of the straight transport path in order to carry out the recording operation over the both sides of the non-rigid medium, the transport path switching device comprising:

a rotatable gate member, provided at a portion in which the medium inverting path is branched from the straight transport path; and

a flap, formed with the gate member and adapted to guide the non-rigid medium to the medium inverting paths wherein

when the rigid medium is transported, a part of the rigid medium acts on the gate member directly or indirectly, thereby rotating the gate member in such a direction that the flap is opened, and the rigid medium can pass through a position of the flap to advance straight.

The present disclosure relates to the subject matter contained in Japanese patent application Nos. 2006-80867 filed on Mar. 23, 2006 and 2006-240558 filed on Sep. 5, 2006, which are expressly incorporated herein by reference in its entirety.

### BRIEF DESCRIPTION OF THE DRAWINGS

The invention will be described with reference to the accompanying drawings, wherein like numbers reference like elements.

FIG. 1 is an entire perspective view showing an inner part of a double-sided recording apparatus to which a transport path switching device is applied.

FIG. 2 is a perspective view showing a driving wheel train portion of the double-sided recording apparatus.

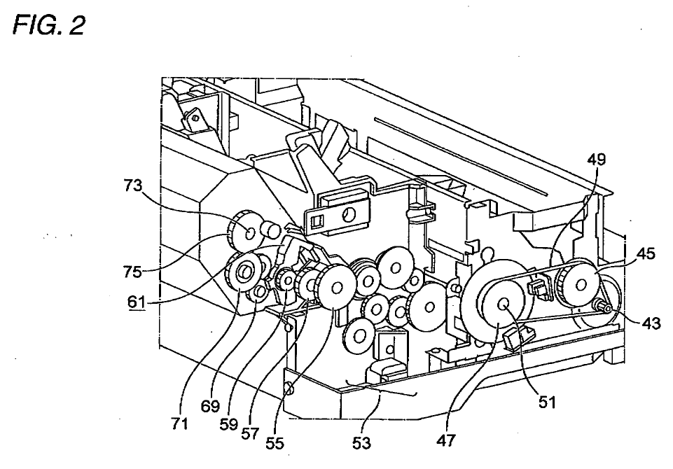

FIG. 3 is a perspective view showing an inverting unit.

FIG. 4 is a sectional view showing two transport paths.

FIG. 5 is a perspective view showing the driving wheel train portion in a normal rotation of a feed driving roller without a use of the inverting unit.

FIG. 6 is a perspective view showing the driving wheel train portion in a reverse rotation of the feed driving roller with a use of the inverting unit.

FIG. 7 is a perspective view showing the driving wheel train portion in the normal rotation of the feed driving roller with a use of the inverting unit.

FIG. 8 is a side view showing an operating state of a rotating lever at a start of an insertion of a medium tray.

FIG. 9 is a side view showing the operating state of the rotating lever in a middle of the insertion of the medium tray.

FIG. 10 is a side view showing the operating state of the rotating lever at an end of the insertion of the medium tray.

FIG. 11 is a perspective view showing the operating state of the rotating lever at the start of the insertion of the medium tray.

FIG. 12 is a perspective view showing a positional relationship between a medium to be recorded and the rotating lever.

FIG. 13 is a sectional view showing a path for the inverting unit according to another embodiment.

### DESCRIPTION OF EXEMPLARY EMBODIMENTS

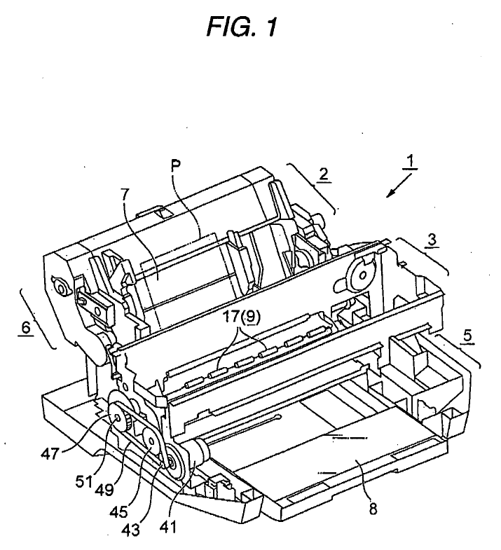

In FIG. 1, the reference numeral 1 denotes a main part of an inner portion of an ink jet printer according to an example of the double-sided recording apparatus. The main part 1 is provided with a medium feeding portion 2, a recording portion 3, a medium receiving portion 5, that is, a CDR feeding portion 5 for transporting a CDR which is a rigid medium to be recorded in the case in which a recording operation is carried out over the CDR, and an inverting unit 6.

The medium feeding portion 2 is provided with a stacker 7 for loading plural media P to be recorded (recording medium P) which is not rigid, for example, a paper, and the media P are fed sequentially one by one to the recording portion 3 from the uppermost medium P. A medium return lever (not shown) is provided in order to separate only the uppermost medium P and to return the residual media P to the stacker 7 side in the case in which the plural media P are fed from the stacker 7 by mistake.

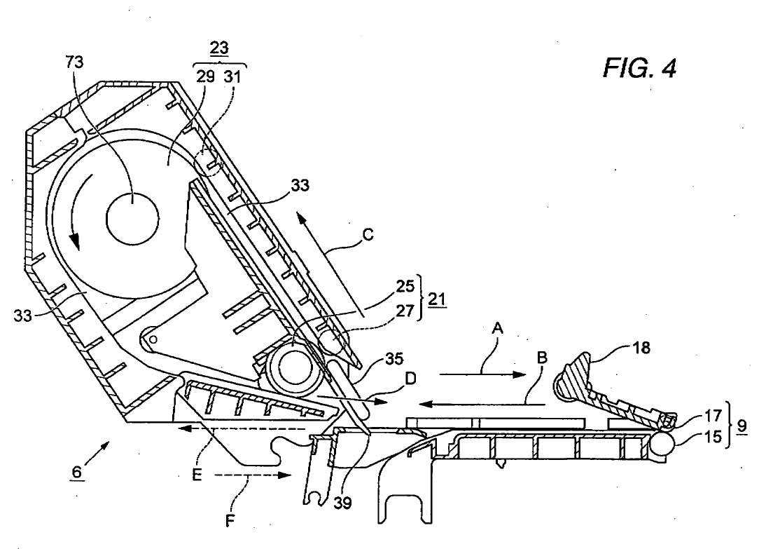

A medium feed roller 9 (see FIG. 4), a carriage (not shown) and a discharge roller (not shown) are provided in the recording portion 3. The medium feed roller 9 is constituted by a feed driving roller 15 and a feed follower roller 17. The feed driving roller 15 is rotatable in both normal and reverse directions and can carry out a precise medium feeding operation to a recording head which will be described below. The feed follower roller 17 is held by a follower roller holder 18 and a tip side of the follower roller holder 18 is urged toward the feed driving roller 15 side by an action of a spring which is not shown so that the feed follower roller 17 is always urged to the feed driving roller 15 at a certain urging pressure. The recording head (not shown) is mounted on the carriage. When the carriage carries out a reciprocating motion in a perpendicular direction to a feeding direction (a main scanning direction), the recording head can carry out a scan for recording in the main scanning direction.

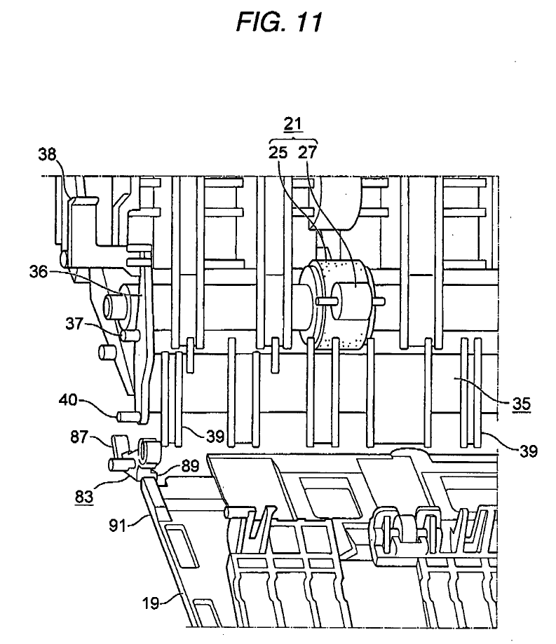

The CDR feeding portion 5 serving as the medium receiving portion is provided for receiving the recorded medium at a discharging stacker 8, and furthermore, feeding a medium tray 19 to the recording portion 3 in a state in which the CDR is mounted on the medium tray 19 (FIG. 11) when carrying out the recording operation over the CDR, and constitutes a separate medium feeding system from the medium feeding portion 2.

Next, description will be given to a structure of the inverting unit 6. As shown in FIG. 4, the inverting unit 6 has such a structure that the medium P which is fed from S the medium feeding portion 2 advances in a direction shown in an arrow A and the recording operation is carried out over a surface of the medium P in the recording portion 3, and the medium P is then returned in a direction of an arrow B, and thereafter passes through paths shown in arrows C and D so that both sides of the medium P are inverted.

The inverting unit 6 having an inverting function of the medium P includes a first medium feed roller 21 provided in the vicinity of a lower end thereof, and a second medium feed roller 23 provided in an uppermost position. The first medium feed roller 21 includes a first medium feed driving roller 25 and a first medium feed follower roller 27, and the second medium feed roller 23 includes a second medium feed driving roller 29 and a second medium feed follower roller 31. A medium inverting path 33 is formed along outer peripheral portions of the first medium feed roller 21 and the second medium feed roller 23.

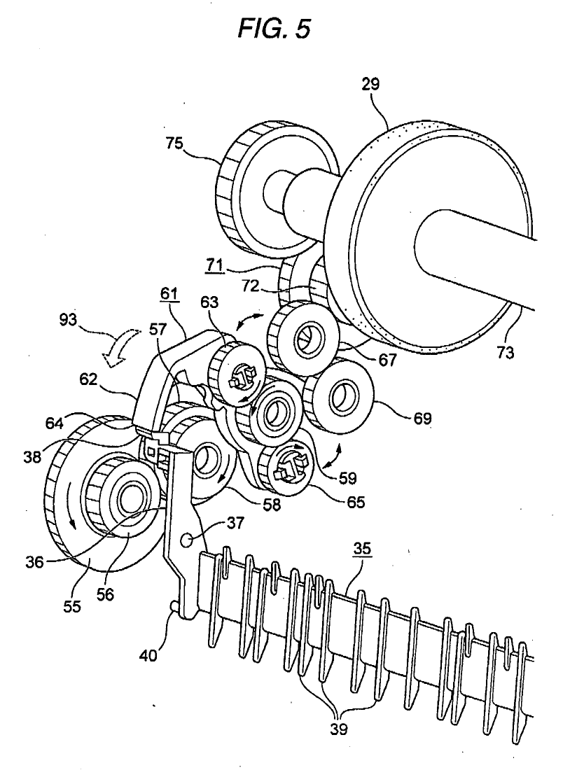

Moreover, a gate member 35 which is rotatable around a rotating shaft 37 (see FIG. 5) is provided in an entry portion of the inverting unit 6, that is, just below the first medium feed roller 21. A plurality of flaps 39 are formed in a transverse direction (width direction) below the gate member 35. Moreover, an extended portion 36 (see FIG. 5) is extended to one end side of the gate member 35, and an abutment receiving portion 38 is formed on an upper end thereof. Furthermore, a guide projection 40 (see FIG. 5) is formed on an opposite side of the gate member 35 to the extended portion 36 with respect to the rotating shaft 37.

When the flaps 39 are moved downward, the medium P which is returned in a direction of the arrow B in FIG. 4 can enter the medium inverting path 33. Consequently, the medium P can be inverted. Thus, a transport path for transporting the medium P in order of the arrows A, B, C, D and A of FIG. 4 by utilizing the medium inverting path 33 to carry out the recording operation over both sides of the medium P is set to be a double-sided recording transport path.

In the case in which the recording operation is carried out over the CDR by using the medium tray 19, moreover, the flaps 39 are moved upward. At this time, the recording operation is carried out over a recording surface of the CDR while the medium tray 19 is straight moved rearward along paths shown in the arrows B and E of FIG. 4, and then, is straight moved forward through the paths of F and A. Thus, a path to be used for carrying out the recording operation over the CDR is set to be a straight transport path.

Description will be given to a drive transmitting system of each driving roller. As shown in FIG. 1, an output pinion 43 is provided on an output shaft of a driving motor 41, and a drive transmitting belt 49 is wound around the output pinion 43, a first transmitting pinion 45 and a second transmitting pinion 47. The feed driving roller 15 is provided on a rotating shaft 51 of the second transmitting pinion 47. By causing the driving motor 41 to carry out a normal rotation or a reverse rotation, accordingly, it is possible to cause the feed driving roller 15 to carry out the normal rotation or the reverse rotation.

A gear which is not shown is fixed to the rotating shaft 51 of the second transmitting pinion 47, and a driving force is transmitted sequentially to a first gear 55, a second gear 57 engaged with a reduction gear 56 of the first gear 55, and a sun gear 59 engaged with a reduction gear 58 of the second gear 57 through a driving transmitting wheel train 53 from the gear. The sun gear 59 has a thickness in an axial direction and has a planetary lever 61 provided on an almost center thereof. The planetary lever 61 is provided with a first planetary gear 63 and a second planetary gear 65. The first planetary gear 63 and the second planetary gear 65 ate engaged with the sun gear 59, respectively. An arm portion 62 is extended from an upper end of the planetary lever 61 and an abutting portion 64 is formed on a tip of the arm portion 62.

On the other hand, a first connecting gear 67 and a second connecting gear 69 engaged with the first connecting gear 67 are provided in an adjacent position to the sun gear 59. By a principle of the planetary gear, the first planetary gear 63 is engaged with the first connecting gear 67 when the sun gear 59 is rotated in a clockwise direction of FIG. 5, and the second planetary gear 65 is engaged with the second connecting gear 69 when the sun gear 59 is rotated in a counterclockwise direction. Furthermore, a reduction gear 72 of a third gear 71 is engaged with the first connecting gear 67, and the third gear 71 is engaged with a fourth gear 75 provided on one end side of a rotating shaft 73 of the second medium feed driving roller 29. A planetary gear mechanism includes the sun gear 59, the first planetary gear 63, the second planetary gear 65, the first connecting gear 67, the second connecting gear 69 and the planetary lever 61.

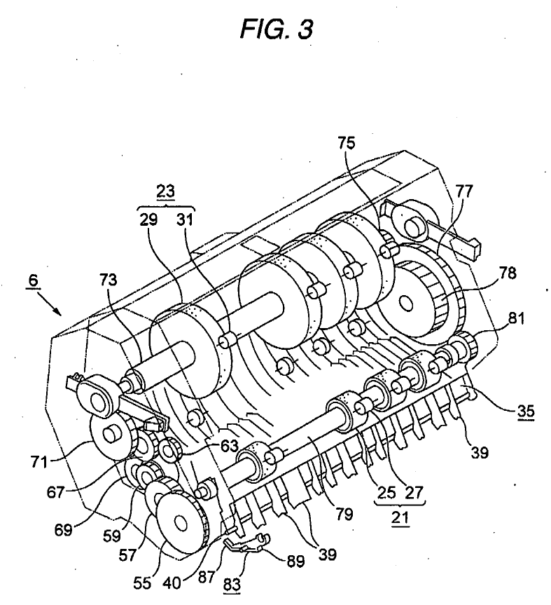

As shown in FIG. 3, the fourth gear 75 is provided on the other end side of the rotating shaft 73 of the second medium feed driving roller 29 and is engaged with a reduction gear 78 of a fifth gear 77, and furthermore, a sixth gear 81 provided on an end of a rotating shaft 79 of the first medium feed driving roller 25 is engaged with the fifth gear 77.

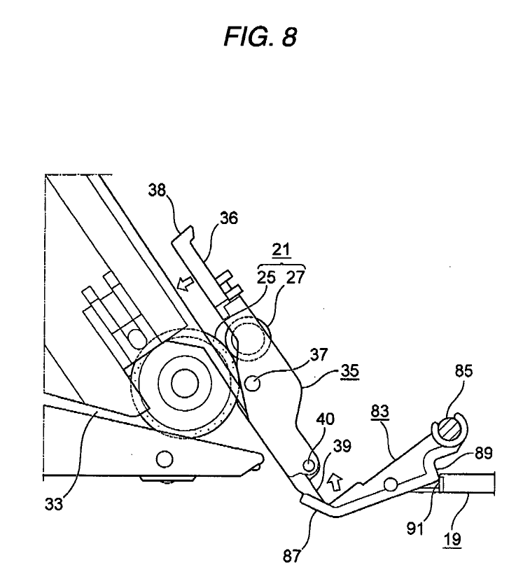

Next, a structure of a transport switching device according to the invention will be described with reference to FIGS. 8 to 12. As shown in FIG. 8, a retracting member 83 is provided on a recording portion side of the gate member 35. The retracting member 83 can be rotated (pivoted) in a vertical direction around a rotating shaft 85, and a retracting portion 87 bent obliquely upward is formed on a tip side thereof and an abutting surface 89 is formed on a lower side which is close to the rotating shaft 85. As will be described below in detail, when the retracting member 83 is rotated upward, the retracting portion 87 has the function of lifting the guide projection 40 of the gate member 35 so as to scoop the guide projection 40 from below, thereby rotating the gate member 35 in the counterclockwise direction of FIG. 8. The rotating shaft 85 of the retracting member 83 is coaxial with a rotating shaft of the medium return lever.

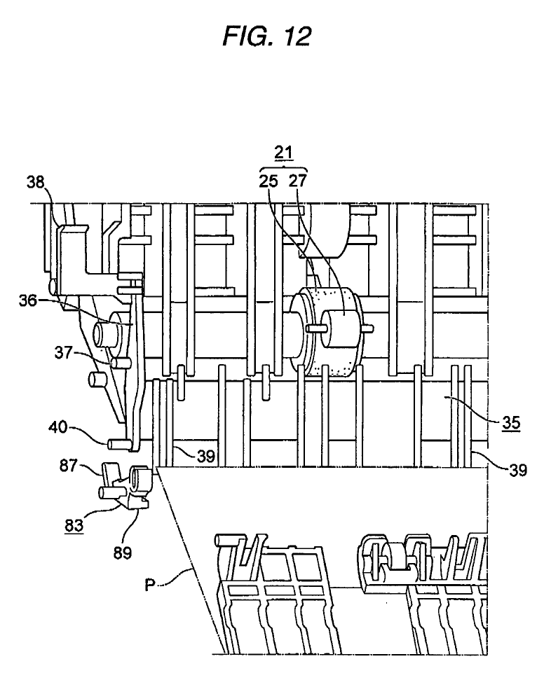

As shown in FIG. 11, the abutting surface 89 is a portion on which an abutting portion 91 formed on a left end of the medium tray 19 abuts when pressing the medium tray 19 in. As shown in FIG. 12, moreover, the retracting member 83 is disposed in such a manner that the medium P which does not use the medium tray 19 and has a maximum width is positioned on an outside of a transport path for the medium P which has the maximum width so as not to interfere with the transport path even if it passes through the transport path.

Next, description will be given to respective functions in the case in which the recording operation is carried S out over a single side of the medium P, the case in which the recording operation is carried out over both sides of one medium P and the case in which the recording operation is carried out over the CDR through the recording apparatus.

### <The Case in Which the Recording Operation is Carried Out Over the Single Side of the Medium P>

The medium P which is fed from the medium feeding portion 2 is transported in the direction of the arrow A in FIG. 4 and the feed driving roller 15 carries out a normal rotation so that the medium P reaches the recording portion 3, and the recording operation is carried out over the surface thereof. When the recording operation over the surface is ended, the medium P is exactly discharged to the discharging stacker 8 by means of a discharge roller. Thus, the recording operation is completed.

FIG. 5 shows a state of the drive transmitting system to the inverting unit 6 in the case in which the recording operation is carried out over the single side of the medium P. At this time, the feed driving roller 15 always carries out the normal rotation. Therefore, the gears are rotated in directions shown in the arrows in FIG. 5, respectively. Since the abutting portion 64 of the planetary lever 61 abuts on the abutment receiving portion 38 of the gate member 35 at this time, however, a rocking motion of the planetary lever 61 in a direction of an arrow 93 is regulated. For this reason, the first planetary gear 63 is not engaged with the first connecting gear 67 and the second planetary gear 65 is not engaged with the second connecting gear 69 so that the first medium feed driving roller 25 and the second medium feed driving roller 29 are not driven.

### <The Case in Which the Recording Operation is Carried Out Over Both Sides of One Medium P>

In the same manner as in the case in which the recording operation is carried out over the single side, the medium P to be recorded which is fed from the medium feeding portion 2 is first transported in the direction of the arrow A in FIG. 4 and the feed driving roller 15 carries out the normal rotation so that the medium P reaches the recording portion 3 and the recording operation is carried out over the surface thereof. At this time, the state of the driving transmitting system to the inverting unit 6 is set as shown in FIG. 5. When the recording operation is completed over the surface, the feed driving roller 15 carries out a reverse rotation so that the direction of the transport of the medium P is changed to the direction of the arrow B.

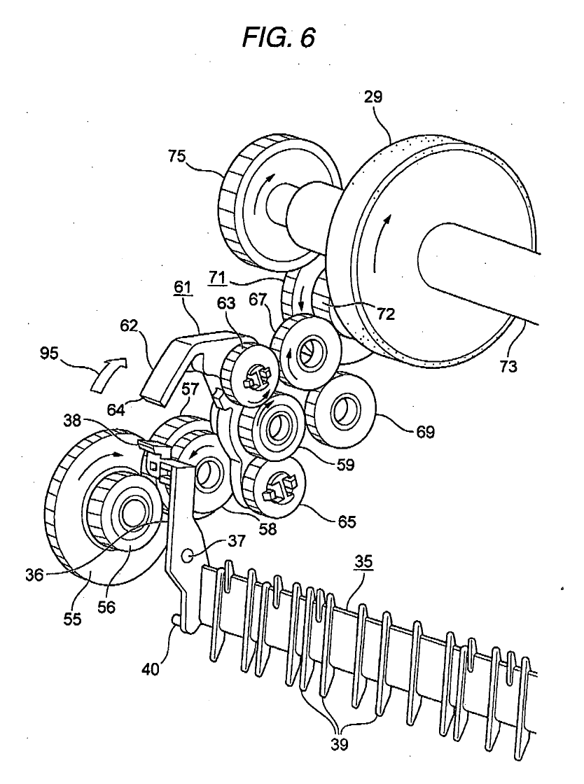

FIG. 6 shows the state of the drive transmitting system to the inverting unit 6 when the feed driving roller 15 carries out the reverse rotation. When the feed driving roller 15 carries out the reverse rotation, the first gear 55, the second gear 57 and the sun gear 59 also carry out reverse rotations as shown in arrows in FIG. 6 respectively so that the planetary lever 61 is rocked in a direction shown in an arrow 95 in FIG. 6. As a result, the first planetary gear 63 is engaged with the first connecting gear 67, and the first connecting gear 67 is rotated in a direction shown in an arrow. As shown in FIG. 3, a driving force is first transmitted to the second medium feed driving roller 29, and furthermore, the driving force is transmitted to the first medium feed driving roller 25 and they are rotated in such a direction as to transport the medium P the medium inverting path 33 in the inverting unit 6, respectively. Moreover, the gate member 35 is brought into a free state and a state in which the flaps 39 come downward is continuously taken by a deadweight thereof.

A tip (leading end) of the medium P which is transported in the direction of the arrow B in FIG. 4 is guided to the medium inverting path 33 by means of the flaps 39 of the gate member 35. Then, the medium P which enters the medium inverting path 33 receives a driving force from the first medium feed driving roller 25 and thus advances in the direction shown in the arrow C in FIG. 4. Furthermore, the medium P also receives the driving force from the second medium feed driving roller 29, and thus passes through a lower side of the medium inverting path 33 and reaches the first medium feed driving roller 25 again. When the medium P reaches the gate member 35, the tip of the medium P pushes the gate member 35 in the free state upward from a rear part as shown in the arrow D and the paper P then advances in the direction of the arrow A. Thus, the medium P passes through the inner part of the inverting unit 6 so that the medium P is inverted to bring a state in which a back face is turned upward. When the tip of the medium P pushes the gate member 35 upward, the extended portion 36 of the gate member 35 is retracted in such a position as not to interfere with the planetary lever 61 in a rocking motion thereof.

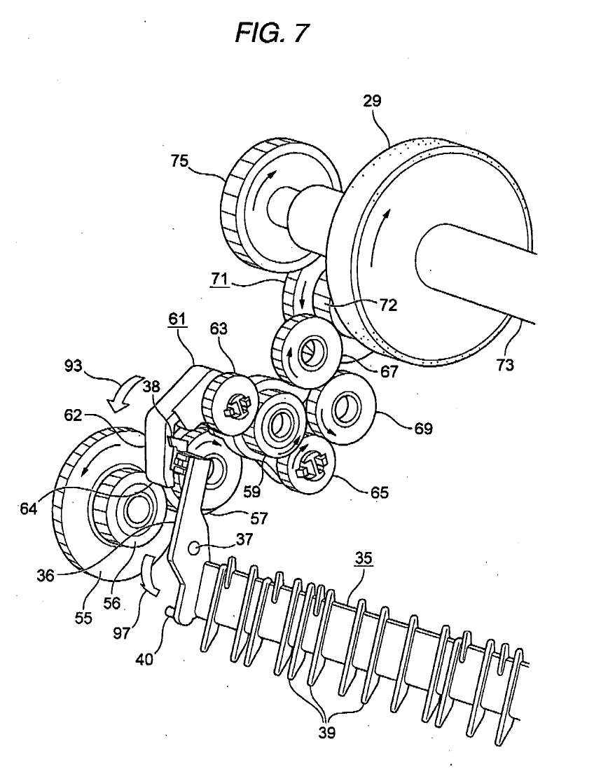

When the tip of the medium P pushes the gate member 35 upward, the rotating direction of the driving motor 41 is changed again after a predetermined time such as a drying time passes so that the feed driving roller 15 starts to be rotated normally. Consequently, the first gear 55, the second gear 57 and the sun gear 59 are also rotated in directions shown in arrows in FIG. 7 respectively, and the planetary lever 61 is rocked in a direction shown in the arrow 93 in FIG. 7. As a result, the second planetary gear 65 is engaged with the second connecting gear 69. Thus, a driving force is transmitted to the first connecting gear 67 through the second connecting gear 69. The rotating direction of the first connecting gear 67 is shown in an arrow of FIG. 7. The direction is similar to a rotating direction in which the feed driving roller 15 carries out the reverse rotation as shown in FIG. 6. Accordingly, the first medium feed driving roller 25 and the second medium feed driving roller 29 are also rotated continuously without a change in the rotating direction. As a result, a rear end side in the advancing direction of the medium P is fed by means of the first medium feed driving roller 25 and a tip side thereof is fed by means of the feed driving roller 15. Therefore, the medium P reaches the recording portion 3 so that the recording operation is executed over the back face. Then, the medium P is discharged to the discharging stacker 8 by means of the discharge roller so that the recording operation is completely carried out over the both sides.

On the other hand, when the tip of the medium P pushes the gate member 35 upward, the planetary lever 61 is rocked in the direction of the arrow 93. Therefore, the arm portion 62 is rotated to such a position as to get over an upper side of the abutment receiving portion 38 of the gate member 35 as shown in FIG. 7. Even if the trailing end of the medium P passes through the gate member 35, accordingly, the arm portion 62 is engaged with the abutment receiving portion 38. Consequently, the rotation of the gate member 35 in a direction of an arrow 97 is regulated by a deadweight thereof. This state is maintained until the feed driving roller 15 changes a rotating direction again.

After the recording operation is completely carried out over the back face, the feed driving roller 15 is reversely rotated again so that the planetary lever 61 is rocked in an opposite direction to the arrow 93. Consequently, the engagement of the arm portion 62 with the abutment receiving portion 38 is released. Therefore, the gate member 35 is rotated by the deadweight and is returned into an initial state in which the flaps 39 are positioned in a lower part (the state shown in FIG. 5). When the feed driving roller 15 is normally rotated again, then, the planetary lever 61 is rocked in the direction of the arrow 93. However, the gate member 35 is rotated into the initial state. For this reason, the abutting portion 64 of the planetary lever 61 abuts on the abutment receiving portion 38 of the gate member 35 so that the planetary lever 61 is regulated so as not to be rocked any more. As shown in FIG. 5, therefore, there is brought an initial state in which the first planetary gear 63 is not engaged with the first connecting gear 67 and the second planetary gear 65 is not engaged with the second connecting gear 69.

### <The Case in Which the Recording Operation is Carried Out Over a Surface of the CDR>

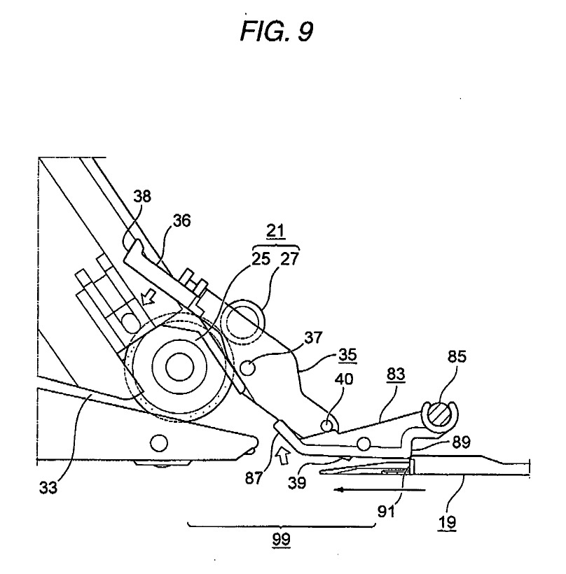

Next, description will be given to a function in the case in which the medium tray 19 is transported from the CDR feeding portion 5 to the straight transport path to carry out the recording operation over the CDR. First of all, when the medium tray 19 is inserted from the CDR feeding portion 5, the abutting portion 91 formed on a left end of the medium tray 19 abuts on the abutting surface 89 of the retracting member 83 and pushes the same in so that the retracting member 83 is rotated in a clockwise direction of FIG. 8 around the rotating shaft 85 as shown in FIGS. 8 to 11. As shown in FIG. 9, consequently, the retracting portion 87 of the retracting member 83 scoops the guide projection 40 of the gate member 35. As a result, the gate member 35 is rotated in a counterclockwise direction of FIG. 9 so that the flaps 39 are moved upward and a straight transport path 99 is thus formed.

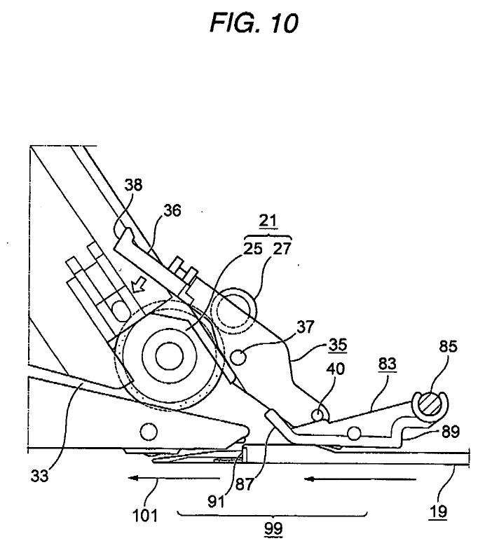

When the rotation is carried out until a bottom face of the retracting member 83 is set into an almost horizontal state as shown in FIG. 10, the abutment of the abutting portion 91 on the abutting surface 89 is released so that the medium tray 19 can advance to a further inner part in a direction shown in an arrow 101 along the straight transport path 99. The medium tray 19 is transported in the direction shown in the arrow 101 through the straight transport path 99 by an accurate driving operation of the medium feed roller 9, and is then transported forward in an opposite direction to the arrow 101 and the recording operation is carried out over a surface of the CDR in the recording portion 3 in the process. After the recording operation, the medium tray 19 is exactly transported through the straight transport path 99 (in the opposite direction to the arrow 101) and is thus discharged.

Although the retracting member 83 is separate from the gate member 35 in the embodiment, a portion having the function of the retracting member may be provided integrally with the gate member 35 and a part of the medium tray may directly act on the gate member 35 in the transport of the medium tray 19 in such a manner that the flaps 39 are moved upward.

### <The Case in Which the Recording Operation is Carried Out Over Both Sides of One Medium P (No. 2)>

When the recording operation is carried out over the surface of the medium P which is fed from the medium feeding portion 2 and the medium P is then fed in the direction of the arrow B in FIG. 4 and is guided to the medium inverting path 33 for the inverting unit 6, the medium P is curved with a back face (a surface to be recorded) turned inward by means of a curving and inverting portion (formed by an outer peripheral surface of the second medium feed driving roller 29) of the medium inverting path 33 and is thus fed in the direction of the arrow D.

At this time, a curl corresponding to a paper quality is formed on the medium P. For example, in case of a medium which is not firm, for example, a plain paper, the curl is rarely formed or slightly formed. In case of a medium which is firm, for example, a postcard, a curl corresponding to an outside diameter of the second medium feed driving roller 29 is formed to some degree. When the recording operation is executed over the back face with the curl generated, thus, there is a possibility that the tip of the medium might be rubbed against the recording head and be thus contaminated or might be caught on the transport path to cause a jam.

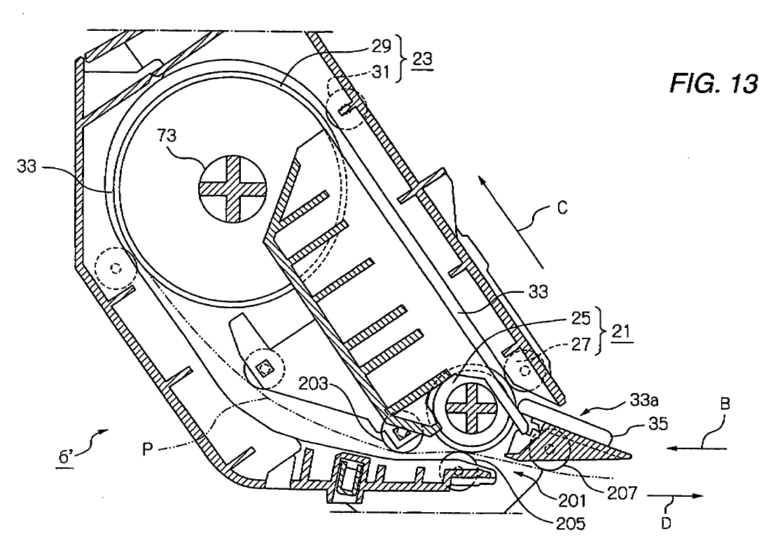

In such a case, it is desirable that a curl correcting device should be provided on a downstream side of a second medium feed driving roller 29 in the inverting unit *6. By providing the curl correcting device in the inverting unit 6, moreover, it is possible to simplify a structure of a recording apparatus body side. FIG. 13 is a sectional view showing a path of an inverting unit 6′ including a curl correcting device 201, and the same components as those shown in FIG. 4 have the same reference numerals.

The curl correcting device 201 includes rollers 203, 205 and 207, and a first medium feed driving roller 25. The rollers 203, 205 and 207 are freely rotatable, and the roller 205 is provided opposite to the first medium feed driving roller 25 and is driven and rotated in contact with the first medium feed driving roller 25. The rollers 203 are provided on an upstream side of the rollers 205 and the rollers 207 are provided on a downstream side of the rollers 205, respectively. The rollers 203, 205 and 207 are provided in plural numbers with a proper interval set in a transverse direction of a medium P.

The rollers 203, 205 and 207 are disposed so as to form a curving path for curving the medium P in a reverse direction to a curving direction of the medium P through the second medium feed driving roller 29. Consequently, a curl formed by passage through the second medium feed driving roller 29 is corrected.

The curl correcting device 201 utilizes the first medium feed driving roller 25. Accordingly, the rollers 207 disposed on the downstream side of the first medium feed driving roller 25 are provided in an entry 33a of a medium inverting path 33. When the medium P is to be transported in a direction of an arrow B and is thus put into the medium inverting path 33, accordingly, the roller 207 narrows the entry 33a of the medium inverting path 33 in a state of FIG. 13. When the medium P is to be put in the medium inverting path 33, however, a gate member 35 is positioned as shown in FIG. 4. The rollers 207 are supported on the gate member 35. Therefore, the rollers 207 are moved downward from a position shown in FIG. 13. Consequently, the entry 33a of the medium inverting path 33 is sufficiently maintained.

While the invention has been described above by taking, as an example, the ink jet printer according to an example of the recording apparatus, it can also be applied to a liquid ejecting apparatus for ejecting a liquid onto a medium to be ejected which is rigid or is not rigid corresponding to a medium to be recorded through a liquid ejecting head in place of a recording head and sticking the liquid to the medium to be ejected.

Furthermore, while the invention has been described above by taking the medium tray on which the CDR that is one example of the rigid medium is mounted, it is possible, in the present invention, to omit the medium tray and to transport only the rigid medium. Here, the rigid medium includes a board sheet. The board sheet has a high-rigidity and cannot be bent. If the board sheet is bent, some defects occur in it. The rigid medium also includes a plastic plate-shaped member such as a substrate.

According to an aspect of the invention, a part of the medium tray acts on the gate member directly or indirectly so that the gate member is rotated in such a direction that the flaps are opened. Consequently, the medium tray can pass through the lower side of the flaps which are opened. Therefore, the medium tray can advance straight and the switching from the medium inverting path to the straight transport path can be reliably carried out irrespective of the rigidity and transporting force of the recorded medium itself.

According to an aspect of the invention, when the abutting portion of the medium tray abuts on the abutting surface of the retracting member in the transport of the medium tray, the retracting member is rotated. As a result, the guiding portion is lifted upward. Consequently, the guiding portion scoops the guide projection. Therefore, the gate member is rotated in such a direction that the flaps are opened. When the retracting member is further rotated in this state, the abutment of the abutting portion and the abutting surface is released so that the medium tray can pass through the position of the flaps to advance straight.

According to an aspect of the invention, it is possible to prevent the medium from interfering with the retracting member when the medium that is not rigid is transported.

According to an aspect of the invention, when the feed driving roller carries out the normal rotation, the planetary lever is originally rotated in such a direction that the second planetary gear is engaged with the second connecting gear. In a state in which the gate member is rotated in such a direction that the flaps are closed, however, the abutting portion abuts on the abutment receiving portion before the second planetary gear is engaged with the second connecting gear. Therefore, the second planetary gear is not engaged with the second connecting gear. In consideration of the rotating direction of the planetary lever, moreover, the first planetary gear is not engaged with the first connecting gear. In the mode for carrying out a recording operation over a single side of a medium that is not rigid, therefore, the driving operation is transmitted to neither the first medium feed driving roller nor the second medium feed driving roller.

According to an aspect of the invention, a part of the medium tray acts on the gate member directly or indirectly so that the gate member is rotated in such a direction that the flaps are opened. Consequently, the medium tray can pass through the lower side of the flap which is opened. Therefore, the medium tray can advance straight and the switching from the medium inverting path to the straight transport path can be reliably carried out irrespective of the rigidity and transporting force of the recorded medium itself.

According to an aspect of the invention, the double-sided recording apparatus includes the curl correcting device for curving the medium on which the curl is formed via the medium inverting path in the reverse direction to a direction of the curl, thereby correcting the curl. Therefore, it is possible to prevent the medium from floating when carrying out the recording operation. Thus, it is possible to obtain an excellent recording result.

According to an aspect of the invention, any of the rollers constituting the curl correcting device which is positioned on the most downstream side is supported on the gate member. Therefore, the roller carries out the rotating operation, that is, the path switching operation together with the gate member. Also in the case in which the roller is disposed in the vicinity of the entry of the medium inverting path, consequently, it is possible to sufficiently maintain an entering path for the medium which enters the medium inverting path.

What is claimed is:

1. A transport path switching device in a double-sided recording apparatus having a mode for carrying out a recording operation over a single side of a non-rigid medium, a mode for carrying out the recording operation over both sides of the non-rigid medium, and a mode for carrying out the recording operation over a rigid medium, the transport path switching device for switching a straight transport path for carrying out the recording operation over the rigid medium and a double-sided recording transport path having a medium inverting path branched in a middle of the straight transport path in order to carry out the recording operation over the both sides of the non-rigid medium, the transport path switching device comprising:
a rotatable gate member, provided at a portion in which the medium inverting path is branched from the straight transport path; and
a flap, formed with the gate member and adapted to guide the non-rigid medium to the medium inverting path, wherein
when the rigid medium is transported, a part of the rigid medium acts on the gate member directly or indirectly, thereby rotating the gate member in such a direction that the flap is opened, and the rigid medium can pass through a position of the flap to advance straight.

2. The transport path switching device in the double-sided recording apparatus according to claim 1, wherein
the rigid medium is transported in a state in which the rigid medium is mounted on a medium tray, and
when the medium tray on which the rigid medium is mounted is transported, a part of the medium tray acts on the gate member directly or indirectly, thereby rotating the gate member in such the direction that the flap is opened, and the medium tray can pass through the position of the flap to advance straight.

3. The transport path switching device in the double-sided recording apparatus according to claim 2, wherein
the gate member is provided with a guide projection,
the medium tray is provided with an abutting portion,
a rotatable retracting member is provided in the vicinity of the gate member, the retracting member includes: a guiding portion for scooping the guide projection when the retracting member is rotated; and an abutting surface on which the abutting portion abuts to rotate the retracting member when the medium tray is transported, and
when the retracting member is rotated in a predetermined amount or more, an abutment of the abutting portion and the abutting surface is released so that the medium tray can pass through the position of the flap to advance straight.

4. The transport path switching device in the double-sided recording apparatus according to claim 3, wherein
the retracting member is positioned on an outside of a transport path for the non-rigid medium having a maximum width.

5. The transport path switching device in the double-sided recording apparatus according to claim 2, further comprising:
a feed driving roller for carrying out a feed driving operation for the non-rigid medium or the rigid medium to a recording portion; and.
a drive transmitting system for a first medium feed driving roller and a second medium feed driving roller which are adapted to apply a driving force to the non-rigid medium in the medium inverting path, wherein
the drive transmitting system includes a planetary gear mechanism for selectively engaging a first planetary gear and a second planetary gear with a first connecting gear and a second connecting gear, respectively, in order to rotate the first medium feed driving roller and the second medium feed driving roller in a feeding direction in the medium inverting path, irrespective of a rotating direction of the feed driving roller,
the planetary gear mechanism includes a planetary lever having an arm portion on which an abutting portion is formed,
the gate member includes an extended portion which is extended toward a side of the arm portion and is formed with an abutment receiving portion, and
in the mode for carrying out the recording operation over the single side of the non-rigid medium, in a state in which the gate member is rotated in such a direction that the flap is closed, the planetary lever is rotated toward a side of the gate member in conjunction with a normal rotation of the feed driving roller and the abutting portion thus abuts on the abutment receiving portion so that the first planetary gear is not engaged with the first connecting gear and the second planetary gear is not engaged with the second connecting gear, and a driving operation is transmitted to neither the first medium feed driving roller nor the second medium feed driving roller.

6. A double-sided recording apparatus incorporating the transport path switching device according claim 2, wherein
the double-sided recording apparatus has the mode for carrying out the recording operation over the single side of the non-rigid medium, the mode for carrying out the recording operation over the both sides of the non-rigid medium, and the mode for carrying out the recording operation over the rigid medium on the medium tray in the state in which the rigid medium is mounted on the medium tray.

7. The double-sided recording apparatus according to claim 6, wherein
the medium inverting path has a curving and inverting portion for curving and inverting the non-rigid medium, and
a curl correcting device for curving the non-rigid medium in a reverse direction to a curving direction of the non-rigid medium by the curving and inverting portion to correct a curl formed on the non-rigid medium by the curving and inverting portion is provided at a downstream side of the curving and inverting portion.

8. The double-sided recording apparatus according to claim 7, wherein
the curl correcting device includes a curving path for curving the non-rigid medium in the reverse direction to the curving direction of the non-rigid medium by the curving and inverting portion, and
the curving path includes a plurality of rollers and one of the rollers which is positioned at a most downstream side is supported on the gate member.

9. A transport path switching device in a double-sided liquid ejecting apparatus having a mode for ejecting a liquid onto a single side of a non-rigid medium, a mode for ejecting the liquid onto both sides of the non-rigid medium, and a mode for ejecting the liquid onto a rigid medium, the transport path switching device for switching a straight transport path for ejecting the liquid onto the rigid medium and a double-sided liquid ejecting transport path having a medium inverting path branched in a middle of the straight transport path in order to eject the liquid onto the both sides of the non-rigid medium, wherein
a rotatable gate member, provided at a portion in which the medium inverting path is branched from the straight transport path; and
a flap, formed with the gate member and adapted to guide the non-rigid medium to the medium inverting path, wherein
when the rigid medium is transported, a part of the rigid medium acts on the gate member directly or indirectly, thereby rotating the gate member in such a direction that the flap is opened, and the rigid medium can pass through a position of the flap to advance straight.

10. The transport path switching device in the double-sided liquid ejecting apparatus according to claim 9, wherein
the rigid medium is transported in a state in which the rigid medium is mounted on a medium tray, and
when the medium tray on which the rigid medium is mounted is transported, a part of the medium tray acts on the gate member directly or indirectly, thereby rotating the gate member in such the direction that the flap is opened, and the medium tray can pass through the position of the flap to advance straight.

11. A double-sided liquid ejecting apparatus incorporating the transport path switching device according to claim 10, wherein
the double-sided liquid ejecting apparatus has the mode for ejecting the liquid onto the single side of the non-rigid medium, the mode for ejecting the liquid onto the both sides of the non-rigid medium, and the mode for ejecting the liquid onto the rigid medium on the medium tray in the state in which the rigid medium is mounted on the medium tray.

12. A transport path switching device operable to switch a first transport path adapted to transport a first medium and a second transport path connected to the first transport path at a connection point and adapted to transport a second medium less than the first medium in rigidity while turning inside out, the transport path switching device comprising:
a rotatable gate member, provided at the connection point; and
a flap, formed with the gate member and adapted to guide the second medium to the second transport path, wherein
when a part of the transported first medium acts on the gate member so as to rotate the gate member, the first medium is transported in the first transport path through the gate member.
